(19) United States
(12) Patent Application Publication
(10) Pub. No.: US 2004/0157640 A1
(43) Pub. Date: Aug. 12, 2004

(54) System and method for counting user equipments (UEs) in idle mode in a multimedia broadcast multi-service (MBMS)

(76) Inventors: Juho Pirskanen, Tampere (FI); Sinikka Sarkkinen, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/630,976

(22) Filed: Jul. 31, 2003

Related U.S. Application Data
(60) Provisional application No. 60/446,264, filed on Feb. 11, 2003.

(51) Int. Cl. H04M 1/00

(52) U.S. Cl. 455/552.1; 455/550.1

(57) ABSTRACT

A method of validating user equipment for a multimedia broadcast service comprises allocating a unique identifier value to a user equipment, wherein the unique identifier value is in a range of values reserved for the multimedia broadcast service.

### CROSS REFERENCE TO RELATED APPLICATIONS

This application claims priority of U.S. Provisional Patent Application entitled, “Counting for IDLE Mode in UE in MBMS,” Serial No. 60/446,264, filed Feb. 11, 2003, the entire contents of which are incorporated herein by reference.

### BACKGROUND OF THE INVENTION

1. Field of the Invention

The present invention relates to the field of multimedia broadcast services, and particularly but not exclusively to the provision of such services in a mobile telecommunication system.

2. Description of the Related Art

3GPP TS25.346: “Introduction of the Multimedia Broadcast Multicast Service (MBMS) in the Radio Access Network” is a standard associated with the provision of multimedia broadcast/multi-services in mobile communication systems. Such broadcasts may be provided on a point-to-multipoint multipoint channel, i.e. a shared channel from the network to multiple user equipment, or on a point-to-point channel, i.e. on a dedicated channel from the network to each user equipment.

In TS25.346, it is defined that multicast data reception from the point-to-multipoint channel must be possible in all radio resource control (RRC) connected states and also in IDLE mode. There is also defined a requirement that the radio access network (RAN) should have means to calculate the number of user equipments (UEs) joined to a specific multimedia broadcast multi-service (MBMS) service, so that a usage decision between a point-to-point (PTP) channel or a point-to-multipoint (PTM) channel over the radio interface can be made. The selection is operator dependent, typically based on downlink radio resource environment such as radio resource efficiency. A threshold related to the number of users may be utilized, resulting in the need for a mechanism to identify the number of subscriber sin a given area.

The number of UEs associated with a service may be used in this decision. For example, in situations where less than x UEs are joined in a cell then the RNC may establish point-to-point channels for each UE to transmit the MBMS data from the network, and if x or more UEs are joined in the cell the RNC may use a single point-to-multipoint channel to transmit the MBMS data to all UEs simultaneously. X in this context corresponds to a UE threshold value for connection type selection, which is implementation dependent and can be defined, for example, by the operator or network admission control. It may be different in each cell. An example value for X is 10.

This technique is described in TS25.346. Point-to-multipoint reception applies to all RRC states and modes, subject to UE capability. These modes include both IDLE mode and RRC connected mode.

In addition to determining the actual number of legitimate UEs for receiving the MBMS session in question in the cell, other cell parameters, measurements and conditions can be used to determine the threshold value x for the selection of the PTP or PTM channel. However, the number of UEs is the most significant factor in this decision.

UEs which receive MBMS sessions are said to be ‘joined’. This means that before the reception of an MBMS session the UE must perform a so-called “join” procedure, upon which the UE indicates its willingness to receive the MBMS service session. This phase is always performed by using the point-to-point connection and therefore it is secure, which allows the possibility to send session specific parameters in secure form.

For the UEs which are in the RRC connected/PMM connected state, the information of the joined UEs can be provided from the core network (CN) to the radio access network (RAN), so that the radio network controller (RNC) can calculate the UEs in CELL_DCH, CELL_FACH or CELL_PCH states for the correct cell. The CELL-DCH is the Cell Dedicated channel state, the CELL-FACH is the Cell Fast Access Channel state, the CELL-PCH is the Cell Paging channel state, and the URA-PCH is the UTRAN Registration Area Paging channel state.

This means that the CN is aware of the UEs that have performed joining, and which at the CN side are in the PMM connected state (i.e. for these UEs the CN has allocated a dedicated signaling link over the Iu interface, i.e. between the SGSN and RNC).

The CN is aware of the following UE related information: the state of the UE in the CN (i.e. PMM connected state versus PMM Idle state); and the number of requested services i.e. radio access bearers (RABs) and the quality of service parameters.

The CN is not aware of: the state of the UE at the RAN side (i.e. CELL-DCH, CELL-FACH, CELL-PCH or URA-PCH); the status and the number of the allocated resources for the RABs from the RAN and air interface; the condition of the air interface; and any made measurements concerning the condition of the air interface and resource evaluation of the RAN.

Thus the CN has information about the UEs, which are in a Packet Mobility Management (PMM) connected state and which have performed the successful joining operation between the network and the UE.

However, the majority of the UEs are in RRC IDLE/PMM IDLE mode, and thus a calculation process for these UEs is required, as the core network delivery of the required information about joining to the correct RNCs cannot be utilized, due to lack of accurate UE location information in the CN (i.e. the location of the UE in PMM IDLE mode is only known at the Location/Routing area level, which may consist of a number of RNCs).

One straightforward solution is to require a UE in IDLE mode to request the establishment of an RRC connection, so that all UEs can be counted. However such a solution would introduce a network capacity consumption peak due to RRC connection establishment signaling.

As a consequence, there has been proposed a new signaling flow for counting those UEs in RRC IDLE mode so that network capacity consumption is reduced. FIG. 1 illustrates the proposed signaling flow. As illustrated in FIG. 1, the UTRAN 104 broadcasts a MBMS Notification Counting message 106 which is received by all UEs in RRC IDLE mode, such as UE 102. The UE 102 returns a MBMS Group Membership report message 108 to the UTRAN 104. Thereafter the UTRAN 104 broadcasts a MBMS Notification “Counting Stopped” Message 110 to the UE 102.

However, there is a problem with such proposed signaling flow, in the integrity of the MBMS group membership report message from the UE. Because the message is sent from the UE with the UE in IDLE mode as an RRC: RRC Connection Request message, the Rel99-5 integrity protection cannot be applied. The group membership report message may be provided by a new message. Due to fact that the MBMS group report is not Rel99-5 integrity protected, the RNC is unable to decide whether the message has been sent by a UE, which is genuinely subscribed and joined to the specific MBMS service.

A particularly problematic consequence from this is that a stolen or incorrectly working UE or UEs may send a high number of the MBMS group membership report messages, which could initiate PTM transmission in a cell even though there are no joined UEs in cell. The stolen or incorrectly working UE or UEs would in any event not be able to read the PTM MBMS data transmission due to the fact that security keys are passed to the UE in the joining phase, which is done by PTP connection with Rel99-5 integrity protection.

Thus the integrity problem does not effect on the security of the MBMS data transmission but may lead to the unnecessary transmission of MBMS data to a cell, or incorrect PTM channel selection.

It is an aim of the present invention to address one or more of the above stated problems.

### SUMMARY OF THE INVENTION

According to the present invention there is provided a method of validating user equipment for a multimedia broadcast service, comprising allocating a unique identifier value to a user equipment, the unique identifier value being in a range of values reserved for the multimedia broadcast service.

There may be a plurality of multimedia broadcast services, there being a non-overlapping range of values reserved for each respective multimedia broadcast service. The unique identifier may be based on a unique factor for the multimedia broadcast service. The unique identifier may be based on a unique identifier of the user equipment. The unique identifier of the user equipment may be an IMSI. The unique identifier of the user equipment may be a UE specific identification. The unique identifier may be based on a unique factor for the multimedia broadcast service. The unique factor for the multimedia broadcast service may be a service identifier.

The unique identifier may be based on a combination of a factor associated with the multimedia broadcast service, an identifier of the multimedia broadcast service, and an identifier of the user equipment. The unique identifier value may be transmitted from the user equipment to an associated network during multimedia broadcast service counting.

The counting may determine the number of user equipment associated with the multimedia broadcast service.

There may be provided a threshold value corresponding to a predetermined number of user equipment, wherein if the threshold is exceeded the counting is terminated.

The number of user equipment associated with the multimedia broadcast service may be used to determine whether the broadcast should use point-to-point or point-to-multipoint channels.

There may be provided a threshold value corresponding to a predetermined number of user equipment, wherein if the threshold value is exceeded a point-to-multipoint channel is used.

The unique identifier may be transmitted as part of a group membership report message. The unique identifier value may be transmitted from the user equipment when the user equipment is an idle mode. The unique identifier value may be transmitted from the user equipment when the user equipment is in a URA_PCH mode.

According to another embodiment of the present invention there is provided a user equipment adapted to validate a multimedia broadcast service, comprising means for determining a unique identifier value for the user equipment, the unique identifier value being in a range of values reserved for said multimedia broadcast service.

There may be further provided means for transmitting the unique identifier to a radio access network in which the user equipment is connected. The unique identifier may be based on a unique factor for the multimedia broadcast service. The unique factor may be received from a core network.

The unique identifier may be based on a unique identifier of the user equipment. The unique identifier may be based on a unique identifier for the multimedia broadcast service. The unique identifier may be based on a combination of a factor associated with the multimedia broadcast service, an identifier of the multimedia broadcast service, and an identifier of the user equipment. The unique identifier value may be transmitted from the user equipment when the user equipment is an idle mode. The unique identifier value may be transmitted from the user equipment when the user equipment is an active mode.

According to a further embodiment of the present invention there may be provided a network element adapted to validate a user equipment in a multimedia broadcast service, comprising means for receiving a unique identifier value for the user equipment from the user equipment, and means for determining if the unique identifier value is in a range of values reserved for said multimedia broadcast service.

The network element may comprise a radio access network element. The network element may receive the range of values from the core network.

The network element may be further adapted to transmit to the user equipment a unique factor for the multimedia broadcast service, wherein the unique identifier value for the user equipment is based on the unique factor. The network element may be a radio access element further adapted to receive the unique factor from a core network. The network element may be further adapted to transmit a unique identifier of the multimedia broadcast service, wherein the unique identifier value for the user equipment is based on the unique identifier of the service. The network element may be a radio access element further adapted to receive the unique factor from a core network.

The network element may further comprise means for counting the number of unique identifier values received.

There may be provided a threshold value corresponding to a predetermined number of user equipment, wherein if the threshold is exceeded the counting is terminated. The number of user equipment associated with the multimedia broadcast service may be used to determine whether the broadcast should use point-to-point or point-to-multipoint channels. There may be provided a threshold value corresponding to a predetermined number of user equipment, wherein if the threshold value is exceeded a point-to-multipoint channel is used.

The unique identifier may be received as part of a group membership report message. The counting means may be adapted such that if a unique identifier value is received more than once, it is counted only once. If a received unique identifier value is not in the defined range it may be ignored.

The means for receiving may be additionally adapted to receive an identifier of the multimedia broadcast service from the user equipment, wherein there is further provided means for comparing the received service identifier does not correspond to the range of values to determine if the received service identifier is not associated with the range of values.

### BRIEF DESCRIPTION OF THE DRAWINGS

The invention will be described hereinafter by way of example with reference to the accompanying drawings in which:

FIG. 1 illustrates a known proposed technique for counting the UEs in IDLE mode;

FIG. 2 illustrates the MBMS joining phase and the counting of IDLE mode UEs in accordance with a preferred embodiment of the invention; and

FIG. 3 illustrates the organization of a number range for different services in accordance with a preferred embodiment of the present invention.

### DETAILED DESCRIPTION OF THE PREFERRED EMBODIMENTS

The invention is described herein by way of example with reference to a universal mobile telecommunication system (UMTS) in which a multimedia broadcast multi-service is provided.

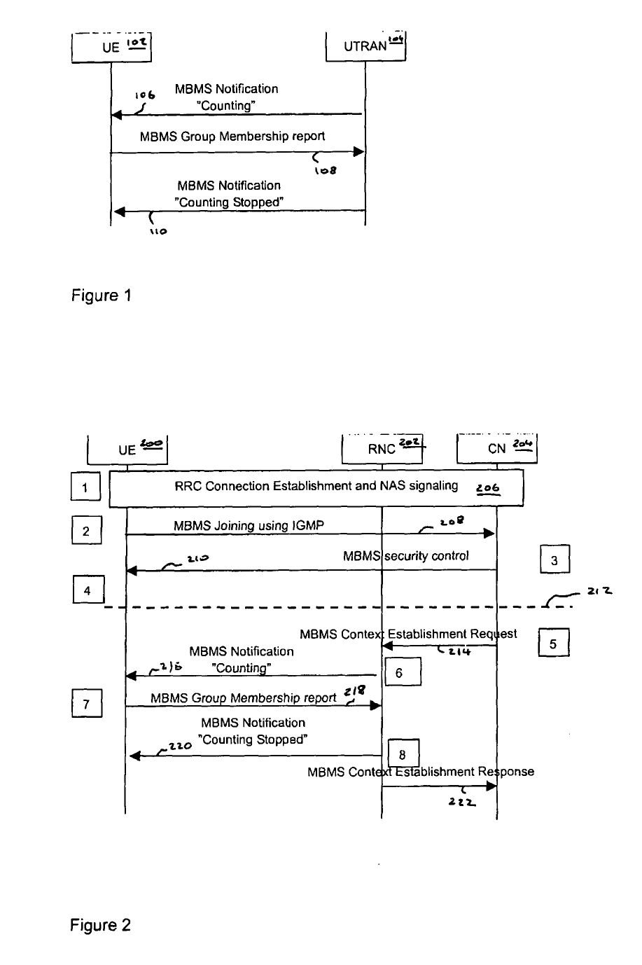

Referring to FIG. 2 there is illustrated a high level signaling chart for the joining phase and the counting of the IDLE mode UEs in accordance with a preferred embodiment of the present invention. For illustrative purposes there is shown a single UE 200, a radio network controller (RNC) 202 of the RAN, and a core network (CN). The implementation and interconnection of these elements in a UMTS network is well-known to one skilled in the art, and outside the scope of the present invention.

In a first step, the LE establishes the RRC connection and uses non-access stratum level (NAS) signaling for authentication and routing area update purposes as in Rel99-5. Thus the NAS signaling is protected by Rel99-5 integrity and security functions. This is well-known in the art, and is represented in FIG. 2 by a general signaling block 206.

In a second step, the LE 200 sends an IGMP (Internet Group Management Protocol) joining message (by using the user plane resources) to the CN 204 in order to join the specific MBMS service and/or MBMS service session(s). The detailed signaling chart of the joining process is not yet finalized in standardization, and is outside the scope of the present invention. This is represented in FIG. 2 by message 208.

In a third step, the CN 204 sends an MBMS Security Control message 210, or an equivalent NAS message, during the joining procedure. This message contains security keys for the MBMS sessions which the UE has joined. The message 210 also contains a Service ID, and a parameter n and the possible UE related MBMS, which are used in a preferred embodiment of the invention for counting IDLE mode UEs as discussed further herein.

The Service ID uniquely identifies the specific MBMS service. The parameter n is implementation dependent, and as described hereinbelow is a parameter introduced to allow an integrity check.

The UE related MBMS identification, which identifies the UE uniquely among the UEs who are legitimate to receive the same MBMS service. The used number could be e.g. a subscriber number allocated by service provider.

In a fourth step, as represented by dashed line 212, the joining process ends. If there is no other activity the UE 200 goes back to the IDLE state.

In a fifth step, an MBMS message context 214 is activated by the core network toward the RNC before MBMS data transmission. The exact moment of the initiation of such context is not yet agreed in standardization, but it occurs at least after a first UE has joined the specific MBMS service. In this example, the message context 214 is initiated by the serving GPRS support node (SGSN) of the core network. The message signals the Service ID, the parameter n and the possible new UE related MBMS identification (UE MBMS ID) to the RNC 202.

In a sixth step the RNC starts the notification procedure with a MBMS Notification Counting message 216, informing the UEs that IDLE mode counting is performed for a specific ID included in the message 216, corresponding to the Service ID in message 214.

In a seventh step the UE calculates, using parameter n, the IMSI of the UE or alternatively a UE related MBMS identification (UE MBMS ID), and the Service ID, a UE specific number, termed UEnumber IE, which is reported in an MBMS Group Membership report message 218, together with the Service ID. The UEnumber IE is thus dependent upon a value unique to the service, a value unique to the UE, and a defied parameter (n).

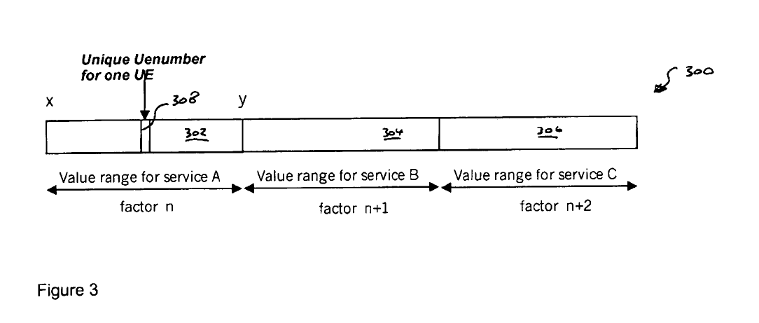

The formulae for determining the UEnumber is implementation dependent. In simple cases the formula may be, for example, UEnumber=(IMSI (or UE MBMS ID) XOR Service ID)*n. More sophisticated algorithms may alternatively be used. The numbers provided in the establishment request message 214 may be used by the RNC to calculate an acceptable UEnumber range for the service, or this range may be given by the SGSN to the RNC along with the pre-mentioned parameters. This is further illustrated with reference to FIG. 3 below.

In an eighth step, the RNC 204 sends an MBMS Notification “Counting Stopped” message 220 to the UE 200, and the core network receives the MBMS group membership report message as part of the MBMS Context Establishment response message 222. The core network compares the UEnumber IE to other received UEnumber IEs.

FIG. 3 illustrates how the numbering may be organized for different services in a preferred embodiment of the invention. The value ranges, generally designated by reference numeral 300, are partitioned according to different services. In FIG. 3, value ranges for three services are shown. A service A has value range 302 having a factor n, a service B has value range 304 having a factor n, and a service C has value range 306 having a factor n. As illustrated in FIG. 3, the service A value range is associated with a factor (parameter) n, the service B value range is associated with a factor (parameter) n+1, the service C value range is associated with a factor (parameter) n+2. The service A value range has an upper limit of y and a lower limit of x. Within the range, each value is associated with one UE, such that the UEnumber 308 represents a unique number.

Because the number for each UE is a UE specific value (e.g. IMSI or UE MBMS ID), all UEs report different values for different services, and for counting purposes messages with a new UEnumber value are accepted. Therefore, a joined UE behaving incorrectly by sending MBMS group membership messages more than once, would be counted only once. Moreover a stolen UE or any non-joined UE would not be able to send a UEnumber IE with a correct value range, because it would not have the correct parameter n and Service ID and UE MBMS ID values, which may be obtained only in the joining phase.

Variations to the above-described embodiments will be apparent to one skilled in the art. For example, UE specific identifications can be used instead of the IMSI. A UE specific identification is a UE specific number, and is unique among the UEs which are also legitimate to receive the same MBMS service. In such case the SGSN should preferably define the range of possible results (the range x to y in FIG. 3) received from UEs in a cell and submit this information to the UTRAN when the corresponding MBMS context is established.

The numbering scheme can be used for all MBMS messages which are sent by the UE to the UTRAN and from which the authorization of the UE may to be confirmed.

The implementation of the present invention depends on the final signaling flow specifications defined in standardization, such as in SA-2 and RAN2/3. However the requirement is preferably for the parameters described herein to be passed to the UE in the joining phase, and to the RNC in the MBMS service context establishment. The UE preferably also reports the output of the defined algorithm in the MBMS group membership report message. The used algorithm can be implementation dependent.

The present invention thus solves the Integrity protection problem in counting IDLE mode UEs, such that unnecessary MBMS data transmissions are not started in the cell, or the PTM channel is not incorrectly selected in the RNC. The solution is simple for implementation in UE, RNC and in CN.

Variations and modifications to the described embodiments are possible without departing from the scope of the present invention. The scope of the present invention is defined by the appended claims.

1. A method of validating user equipment for a multimedia broadcast service, comprising allocating a unique identifier value to a user equipment, the unique identifier value being in a range of values reserved for said multimedia broadcast service.

2. A method according to claim 1 wherein there is a plurality of multimedia broadcast services, there being a non-overlapping range of values reserved for each respective multimedia broadcast service.

3. A method according to claim 1 wherein the unique identifier value is based on a unique factor for the multimedia broadcast service.

4. A method according to claim 1 wherein the unique identifier value is based on a unique identifier of the user equipment.

5. A method according to claim 4 wherein the unique identifier value of the user equipment comprises an IMSI.

6. A method according to claim 4 wherein the unique identifier value of the user equipment comprises a user equipment specific identification.

7. A method according to claim 1 wherein the unique identifier value is based on a unique factor for the multimedia broadcast service.

8. A method according to claim 7 wherein the unique factor for the multimedia broadcast service comprises a service identifier.

9. A method according to claim 1 wherein the unique identifier is based on a combination of a factor associated with the multimedia broadcast service, an identifier of the multimedia broadcast service, and an identifier of the user equipment.

10. A method according to claim 1 wherein said unique identifier value is transmitted from the user equipment to an associated network during multimedia broadcast service counting.

11. A method according to claim 10 wherein said multimedia broadcast service counting determines a number of user equipment associated with the multimedia broadcast service.

12. A method according to claim 11 wherein there is provided a threshold value corresponding to a predetermined number of user equipment, wherein if the threshold is exceeded the multimedia broadcast service counting is terminated.

13. A method according to claim 11 wherein the number of user equipment associated with the multimedia broadcast service is used to determine whether the broadcast uses point-to-point or point-to-multipoint channels.

14. A method according to claim 13 wherein there is provided a threshold value corresponding to a predetermined number of user equipment, wherein if the threshold value is exceeded a point-to-multipoint channel is used.

15. A method according to claim 1 wherein said unique identifier is transmitted as part of a group membership report message.

16. A method according to claim 10 wherein the unique identifier value is transmitted from the user equipment when the user equipment is an idle mode.

17. A method according to claim 10 wherein the unique identifier value is transmitted from the user equipment when the user equipment is in a URA_PCH mode.

18. A user equipment configured to validate a multimedia broadcast service, comprising means for determining a unique identifier value for the user equipment, the unique identifier value being in a range of values reserved for said multimedia broadcast service.

19. A user equipment according to claim 18 wherein there is further provided means for transmitting said unique identifier to a radio access network in which the user equipment is connected.

20. A user equipment according to claim 18 wherein the unique identifier is based on a unique factor for the multimedia broadcast service.

21. A user equipment according to claim 20 wherein the unique factor is received from a core network.

22. A user equipment according to claim 18 wherein the unique identifier is based on a unique identifier of the user equipment.

23. A user equipment according to claim 18 wherein the unique identifier is based on a unique identifier for the multimedia broadcast service.

24. A user equipment according to claim 18 wherein the unique identifier is based on a combination of a factor associated with the multimedia broadcast service, an identifier of the multimedia broadcast service, and an identifier of the user equipment.

25. A user equipment according to claim 18 wherein the unique identifier value is transmitted from the user equipment when the user equipment is an idle mode.

26. A user equipment according to claim 18 wherein the unique identifier value is transmitted from the user equipment when the user equipment is an active mode.

27. A network element adapted to validate a user equipment in a multimedia broadcast service, comprising means for receiving a unique identifier value for the user equipment from the user equipment, and means for determining if the unique identifier value is in a range of values reserved for said multimedia broadcast service.

28. A network element according to claim 27, comprising a radio access network element.

29. A network element according to claim 28, wherein the network element receives the range of values from the core network.

30. A network element according to claim 27 further adapted to transmit to the user equipment a unique factor for the multimedia broadcast service, wherein the unique identifier value for the user equipment is based on the unique factor.

31. A network element according to claim 27 wherein the network element comprises a radio access element further adapted to receive the unique factor from a core network.

32. A network element according to claim 27 further adapted to transmit to a unique identifier of the multimedia broadcast service, wherein the unique identifier value for the user equipment is based on the unique identifier of the service.

33. A network element according to claim 32, wherein the network element comprises a radio access element further adapted to receive the unique factor from a core network.

34. A network element according to claim 27 further comprising means for counting a number of unique identifier values received.

35. A network element according to claim 34 wherein there is provided a threshold value corresponding to a predetermined number of user equipment, wherein if the threshold is exceeded the counting is terminated.

36. A network element according to claim 34 wherein the number of user equipment associated with the multimedia broadcast service is used to determine whether the broadcast uses point-to-point or point-to-multipoint channels.

37. A network element according to claim 34 wherein there is provided a threshold value corresponding to a predetermined number of user equipment, wherein if the threshold value is exceeded a point-to-multipoint channel is used.

38. A network element according to claim 27 wherein said unique identifier value is received as part of a group membership report message.

39. A network element according to claim 34, in which said counting means is adapted such that if a unique identifier value is received more than once, the unique identifier value is counted only once.

40. A network element according to claim 27 wherein if a received unique identifier value is not in the defined range it is ignored.

41. A network element according to claim 27 wherein the means for receiving is additionally adapted to receive an identifier of the multimedia broadcast service from the user equipment, wherein there is further provided means for comparing the received service identifier with the range of values to determine if the received service identifier is not associated with the range of values.
